(19) United States
(12) Patent Application Publication
(10) Pub. No.: US 2008/0130749 A1
(43) Pub. Date: Jun. 5, 2008

(54) Method for Performing Pattern-Based Block Motion Estimation

(76) Inventors: Chang-Che Tsai, Hsinchu Hsien (TW); Tzu-Yi Chao, Hsinchu Hsien (TW); Hsueh-Ming Hang, Hsinchu Hsien (TW)

Correspondence Address: J. NICHOLAS GROSS, ATTORNEY, 2030 ADDISON ST., SUITE 610, BERKELEY, CA, 94704, US

(21) Appl. No.: 11/752,452

(22) Filed: May 23, 2007

Related U.S. Application Data
(60) Provisional application No. 60/747,962, filed on May 23, 2006.

(51) Int. Cl. H04N 7/32

(52) U.S. Cl. 375/240.16; 375/E07.123

(57) ABSTRACT

A block motion estimation search method and related search pattern for determining motion vectors of varying image data is disclosed. The patterns are based on genetic competition between paired coordinate points. An evaluation of a block matching cost is used to identify a survivor between the two selected points. Models are also provided for estimating performances of new search algorithms and image sequences.

### CROSS REFERENCE TO RELATED APPLICATIONS

The present application claims the benefit under 35 U.S.C. 119(e) of the priority date of Provisional Application Ser. No. 60/747,962 filed May 23, 2006 and which is hereby annexed hereto as Appendix 1. The application is also related to the following applications which are also filed on the present date:

an application titled System for Performing Pattern-based Block Motion Estimation, Ser. No. ______ (attorney docket no. PIX2007-2);

an application titled Method for Predicting Performance of Patterns Used in Block Motion Estimation Procedures, Ser. No. ______ (attorney docket no. PIX2007-3);

both such applications are hereby incorporated by reference herein.

### FIELD OF THE INVENTION

The present invention relates to processing of digital image data, and more particularly to compression techniques such as block motion estimation and related features which are useful in coding video signal sequences.

### BACKGROUND

Motion estimation (ME) is a tool used frequently in the art of image processing to find a motion vector that best describes an object in one domain and its corresponding object in another domain. Most modern video coding circuits, such as employed in H.26x and MPEG compatible systems, typically adopt a branch of ME, namely so-called block motion estimation (BME) to help eliminate the inter-frame dependencies. For contemporary examples of this type of technique, please see the following, all of which are incorporated by reference herein: [1] Kim et al. “Fast motion estimation apparatus and method using block matching algorithm”, US Patent, Pub. No.: US 2006/0280248 A1, Dec. 14, 2006. [2] Thomas Wiegand, et al. “Overview of the H.264/AVC video coding standard”, IEEE Trans. Circuits Systm. Video Technolog, vol. 13, no. 7, July 2003.

As seen in prior art FIG. 6A BME is used to find a motion vector that best describes a current block in one current image frame and its corresponding reference block within the search area in the other reference frame(s). The location differences of the reference block within the prior frame and co-located block within the current frame are described as the motion vectors. Typically a 16×16, 16×8, 8×16, 8×8, 8×4, 4×8, and 4×4 block are used for the BME procedure. BME is conventionally used in a number of block-matching video compression systems, such as H.261/263/264 as well as MPEG-1/2/4. In a BME approach, reference frames typically consist of the temporal previous coded frame. In some instances it may consist of both the temporal previous coded frames and the temporal successive coded frames.

For example:

Presentation Sequence: I1, P2, B3, P4, B5, P6, B7, B8, P9, B10, P11, B12, P13, I14 . . .

Coding Sequence: I1, P2, P4, B3, P6, B5, P9, B7, B8, P11, B10. P13, B12, I14 . . . .

In deciding which reference block most resembles a current selected block, one usually calculates the corresponding block-matching discrepancy. Any of a number of different techniques may be employed to measure such discrepancy.

One of the most commonly used block-matching discrepancy measures is the sum of absolute differences (SAD). The SAD of a current block having a size N×M compared to a reference block with a displacement of (vₓ,v_{y}) relative to the current block in the reference frame is defined as:

$$SAD ( {v}_{x} , {v}_{y} ) ≡ {\sum }_{i = 1}^{N} {\sum }_{j = 1}^{M} \vert {I}_{n} ( x + i , y + j ) - {I}_{n - 1} ( x + i + {v}_{x} , y + j + {v}_{y} ) \vert$$

where Iₙ is the current frame and Iₙ₋₁ is the reference frame, (x,y) is the location of the current block.

As noted above, in a block-matching algorithm, a current frame of video image data is divided into a plurality of individual current blocks of a particular size. BME finds a corresponding reference block in the search window of the reference frames for each of the blocks. The displacements of the reference blocks from the previous frame to the current frame are determined as respective corresponding motion vectors.

One type of BME algorithm employs what is referred to as a full search (US) algorithm and is shown in FIG. 6B. In US, each reference block within a current frame is compared with all of a plurality of blocks within a predetermined search region of a previous frame. FS is a useful technique in that it provides block matching with high precision and a simple data flow. In addition, the structure of a control circuit used for executing the FS algorithm is relatively simple. However, it can be seen quite easily that the FS algorithm requires a considerable amount of computation, especially when the search region becomes large.

In order to reduce the time/computation requirements associated with FS algorithms, various fast pattern search methods have been suggested. Using a search pattern instead of each block in an entire frame is advantageous as it reduces the number of points to be searched. These search patterns are devised therefore by taking advantage of the characteristics of a distribution of motion vectors, thereby enhancing the speed of the motion estimation process.

While it is known to use different kinds of search patterns for a BME process, the process for determining what kind of pattern to use, and when, is still very much an unpredictable art. Therefore there is a very pronounced and long-felt need for both improved BME search patterns as well as tools for evaluating the performance of potential search patterns, and adaptively identifying which of such patterns may be most appropriate for particular image sequences.

### SUMMARY OF THE INVENTION

An object of the present invention, therefore, is to overcome the aforementioned limitations of the prior art;

One aspect of the invention concerns an adaptive method of performing block motion estimation preferably comprising the following steps: calculating a motion vector variance for at least a first frame; determining a relationship of the motion vector variance to a first threshold for the at least first frame; based on the above: i) selecting a first search pattern for identifying one or more search blocks in a second frame when the motion vector variance has a first relationship to the first threshold; and ii) selecting a second search pattern for identifying one or more search blocks in the second frame when the motion vector variance has a second relationship to the first threshold. In this manner block motion estimation is performed adaptively for one or more frames. In a preferred embodiment, the first relationship requires that the motion vector variance exceed the first threshold, while the second relationship requires that the motion vector variance be equal or less than the first threshold.

The first search pattern and the second search pattern are preferably based on genetic algorithms. The first search pattern is also preferably based on a rhombus shaped algorithm, while the second search pattern is preferably based on a hexagonal shaped algorithm. Typically the first search pattern is preferably adapted for frames in which there is relatively small motion between candidate blocks, and the second search pattern is preferably adapted for frames in which there is relatively large motion in candidate blocks.

In a preferred approach the motion vector variance is determined by analyzing an immediately prior frame, or a sequence of prior frames. It can also be estimated prior to the playback of a sequence of frames. The data for the motion vector variance can thus be coded and integrated as part of a video sequence. In some applications it may be desirable to predict a motion vector variance for a subsequent frame.

Another aspect of the invention concerns a genetic based method of performing block motion estimation for a frame in connection comprising: identifying a parent starting point within the frame; randomly selecting a child point proximate to the first parent starting point; comparing a first block matching cost for the parent point and a second block matching cost for the child point; based on the results above setting either the parent point or the child point as a new surviving parent starting point; repeating the above steps with the new surviving parent starting point acting as the parent starting point until all child points have been examined for one more successive new surviving parent starting points; and identifying a motion vector for the frame, preferably based on a final surviving parent starting point from the successive new surviving parent starting points.

The genetic based block motion estimation process can be based on a rhombus pattern, a hexagonal pattern, or some other geometric shape appropriate for the data in question. In the genetic approach, a first child point which is determined to have a lower block distortion than the parent starting point is selected for the new surviving starting point without computing block distortions of other remaining unchecked child points. Typically the first block matching cost is determined by comparing a sum of absolute differences for the child point and the first parent starting point.

A distance to be used for the child point can also be computed in some instances. In this fashion a first distance is used when there a variance between motion vectors in a prior frame exceeds a predetermined threshold, and a second distance is used otherwise.

Depending on the type of geometric shape, the child point is selected from 4, 6 or some other number of candidate points. In some embodiments the child point is immediately adjacent to the first parent starting point.

A further determination is also made in some cases concerning a direction of the new surviving parent starting point. A number of additional child points checked is preferably based on whether a direction of the new surviving parent starting point is vertical or horizontal.

For some embodiments it may be desirable to further perform a fine searching operation on selected points situated between the parent starting point and the child points situated on the hexagon perimeter portion. The selected points are preferably determined by ranking and identifying which of the child points constitutes a minimum block distortion among the child points. Again a number of selected points which are examined for the fine searching operation is preferably based on whether a horizontal or vertical direction is detected for the motion vector. In this instance fewer selected points are examined when a horizontal direction is detected.

Yet another aspect concerns various systems, including MPEG and H26x compatible architectures, which embody the above processes in some combination of firmware, hardware, or programmed logic. Preferably the aforementioned block motion estimation is performed within a single integrated circuit used as a video encoder.

Still another aspect of the invention concerns various methods and processes for predicting computational performance/requirements of new types of search patterns (measured across multiple image data types), and conversely predicting an appropriate search pattern (from multiple options) for a particular data image file.

In a first aspect of this part of the invention, a prediction can be made for determining a performance of a particular pattern search on image data, comprising the following steps: providing a first sequence of one more image data frames; providing a first pattern for performing block motion estimation on the first sequence of one or more image data frames; wherein the first pattern is derived from training performed on one or more second sequences of image data frames; calculating a variance of motion vectors within the first sequence of one or more image data frames; and calculating an average number of search points for the first pattern and the first sequence preferably based on the prior step. In this manner a computational requirement can be predicted for performing block motion estimation on the first sequence based on using the first pattern.

As suggested above, in some embodiments it is possible to identify and store the first pattern as part of a data file including the first sequence of data frames. The process is preferably used in an encoder so that plurality of separate patterns are adaptively selected for each of a plurality of contiguous sequences of data frames.

Still another aspect concerns a method of processing a sequence of plurality of data frames for pre-recorded image data comprising: providing a plurality of separate block motion estimation procedures for at least one sequence of one more of the plurality of data frames; wherein each of the separate block motion estimation procedures is characterized by a different search pattern for identifying matching blocks within a frame; performing a substantially full search block matching operation to identify a probability distribution of motion vectors within the at least one sequence of data frames; calculating an average number of search points for each of the separate block motion estimation procedures for the at least one sequence of plurality of data frames; and selecting one of the block motion estimation procedures preferably based on the results of step (c). Using this type of methodology an optimal block motion estimation procedure can be identified and optionally stored as part of a data file including the at least one sequence of data frames.

Yet another aspect of the invention concerns a method of predicting a performance of a search pattern to be used for block motion estimating of image data comprising: providing a sequence of one more image data frames; providing a first pattern for performing block motion estimation on the sequence of one or more image data frames; calculating a variance of motion vectors within the sequence of one or more image data frames using at least one second pattern; and calculating an average number of search points for the first pattern preferably based on step (c) for the at least one second pattern. Based on this methodology a computational performance of the first pattern can be predicted for the sequence preferably based on data evaluated for one or more second patterns.

In a preferred embodiment, an average number of search points for the first pattern is estimated from data for the at least one second pattern. At least one of the second patterns is a full search pattern which evaluates each block in a frame.

Another aspect of the invention pertains to a method of estimating a computational requirement for a block motion estimation procedure comprising: calculating a number of search points S(x,y)) associated with a search pattern for the block motion estimation procedure within a frame; calculating a weighting function WF (x,y) associated with the search pattern within the frame; calculating an average number of search points (ASP) required for the block motion estimation procedure substantially in accordance with a formula:

ASP=C1*ΣS(x,y)*WF(x,y)+C2

wherein C1 and C2 are constants, and can be determined by analyzing one or more image sequences.

In preferred embodiments, a motion vector probability function (PD) is calculated by a full search algorithm and is used to derive S(x,y). The motion vector probability function (PD) can also be modified by a variance of motion vectors to derive S(x,y). Typically C1 and C2 are determined by applying a fixed block motion estimation procedure to one or more training image sequences, or by applying one or more block motion estimation procedures to a fixed training image sequence.

A further aspect of the invention covers methods of selecting a pattern to be used in a block motion estimation procedure comprising: providing a set of test sequences of image frames; determining a statistical probability distribution function (PDF) for motion vectors within the set of test sequences of image frames; selecting the pattern for the block motion estimation procedure to be used for new image frames based on the results above. The pattern can then be used as part of a block motion estimation procedure within an encoder.

The statistical probability distribution function (PDF) is preferably determined by calculating a variance in motion vectors resulting from a full search algorithm applied to each block in a frame. A weighting function having minimal values in locations of the frame is also used to determine the pattern. The pattern can be adaptively changed for different image frames within the encoder circuit preferably based on a predicted variance of motion vectors within the image frames.

As will be appreciated from the discussion below, the invention's benefit are not limited to video coding. Other applications that use block motion estimation for detecting visual differences in block matching may adopt the present inventions.

It will be understood from the Detailed Description that the inventions can be implemented in a multitude of different embodiments. Furthermore, it will be readily appreciated by skilled artisans that such different embodiments will likely include only one or more of the aforementioned objects of the present inventions. Thus, the absence of one or more of such characteristics in any particular embodiment should not be construed as limiting the scope of the present inventions. Furthermore, while the inventions are presented the context of certain exemplary embodiments, it will be apparent to those skilled in the art that the present teachings could be used in any application where it would be desirable and useful to detect changes in image data.

### DESCRIPTION OF THE DRAWINGS

FIG. 1A is a flow chart illustrating the steps performed by an adaptive genetic pattern search implemented in accordance with a preferred embodiment of the present invention;

FIGS. 1B-1C are charts depicting a relationship/thresholds associated with a genetic rhombus search pattern (GRPS) and genetic hexagonal search pattern (GEHS) and extended rhombus pattern search (ERPS) versus an extended hexagonal search (EHS);

FIG. 2A is a flow chart illustrating the steps performed by a GRPS implemented in accordance with a preferred embodiment of the present invention;

FIGS. 2B-2C are graphical depictions of a search process implemented within a frame for a preferred genetic rhombus search pattern (GRPS);

FIG. 3A is a flow chart illustrating the steps performed by a GEHS implemented in accordance with a preferred embodiment of the present invention;

FIGS. 3B-3C are graphical depictions of a preferred search process implemented within a frame for a genetic hexagonal search pattern (GEHS);

FIG. 4A is a block diagram depiction of a preferred embodiment of an MPEG encoder integrated circuit/system implemented in accordance with the teachings of the present invention;

FIG. 4B illustrates one form of a motion vector as used in the present invention;

FIG. 5 is a block diagram depiction of a preferred embodiment of an H.26x encoder integrated circuit/system implemented in accordance with the teachings of the present invention;

FIGS. 6A and 6B depict a prior art block motion estimation process.

### DETAILED DESCRIPTION

As described below, the present inventions relate to the following general areas: 1) optimized BME search patterns and procedures; 2) a fast BME integrated circuit or system compressing video image data in real-time/non-real-time using such search patterns; 3) methods for determining optimal BME search patterns for particular image sequences; 4) methods for evaluating different types of BME search patterns across diverse image sequences. These various aspects of the invention are now addressed in detail.

### Optimized BME Search Patterns and Procedures

The optimized search patterns discussed herein include what is referred to herein generally as a “genetic” search. By this it is generally meant that a form of one-on-one competition is introduced in the evaluation process for the individual evaluation points to determine a surviving entity (point). While the invention describes this process in connection with a single 1:1 comparison it should be noted that this principle could be extended to larger collections of pixels.

Accordingly the present invention extends a genetic behavior to different types of pattern searches, most preferably the shapes discussed below, although others could be usd as well. The first type of genetic search which is illustrated is a genetic rhombus pattern search (GRPS), which can be seen to outperform other traditional pattern searches, particularly for certain types of image sequences. A second type of the genetic enhanced search is used with a hexagonal pattern search (GEHS). This approach, as explained below, is useful as it outperforms GRPS for certain types of high motion variances sequences.

Additionally, the present invention combines these two types of genetic search patterns so that a dynamic pattern selection algorithm, preferably implemented as part of a coder integrated circuit, can choose the GRPS or GEHS per the variances of motion vectors measured in the various images. In this fashion the invention teaches an adaptive and flexible coding technique which can accommodate a variety of changing/variable image data.

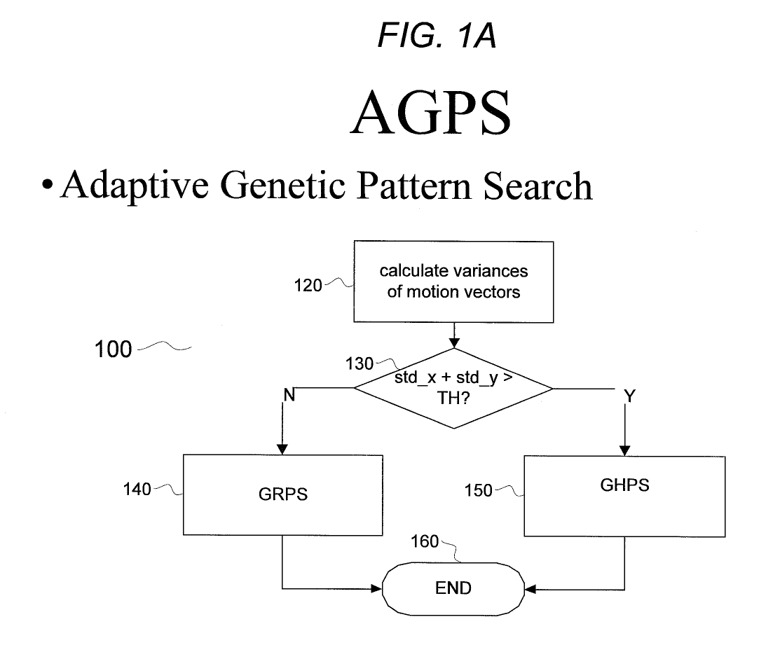

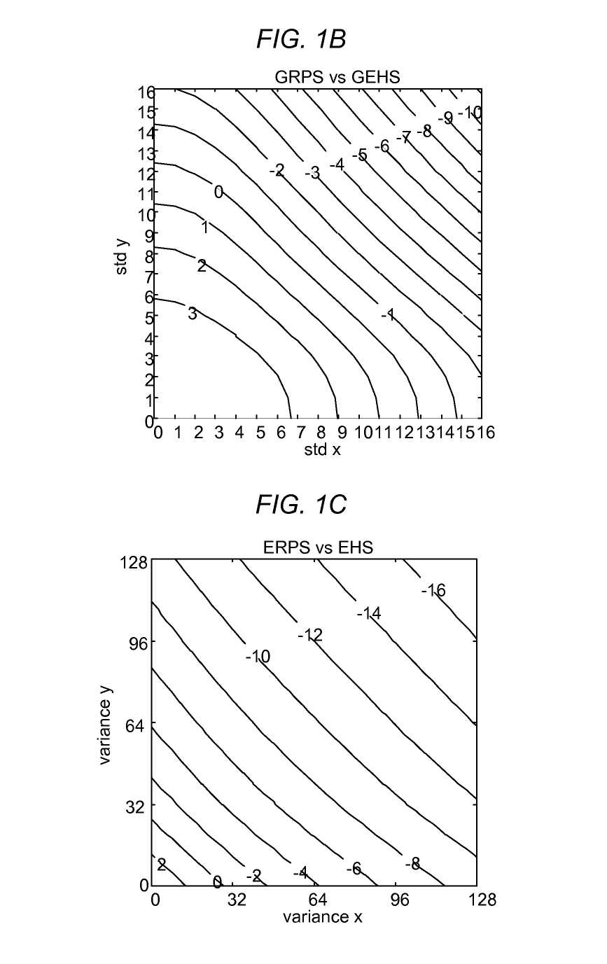

The operation of a preferred embodiment of this adaptive genetic pattern search is illustrated generally in the flowchart of FIG. 1A. As seen therein, this part of the invention takes advantage of the fact that not all search patterns will be appropriate for each type of image frame. To quantify which is more desirable, consider two search algorithms, SA1 and SA2, which are to be applied to a specific sequence. In this instance, the invention preferably uses an enhanced rhombus pattern shape (ERPS) and an enhanced hexagonal shape (EHS) as noted earlier. A primary benchmark of their respective computational complexity is reflected in their average search points (ASP) within a frame. Thus, the difference of ASP can be defined as:

$${D}_{ASP} = {C}_{1} \times {\sum }_{x , y ε A}^{ } {S}_{FS} ( x , y ) \times ( {WF}_{SA 1} ( x , y ) - {WF}_{SA 2} ( x , y ) )$$

where WF_{SA1} and WF_{SA2} represent respective weighting functions for the two search algorithms, SFS represents a number of points required by a full search algorithm, and C₁ is a constant that is derived experimentally from test sequences as elaborated further below. Because WF_{SA1} and WF_{SA2} are fixed, and SFS is a function of the motion vector variances, it is clear that D_{ASP} is a function of motion vector variances. Accordingly for purposes of explaining the present invention, we define I_{ASP} as follows:

I_{ASP}=D_{ASP}/C₁

I_{ASP} represents the performance difference index between the two specific search algorithms and is shown graphically in FIG. 1C, which shows the difference in between ERPS and EHS. The X-axis denotes the motion vector variance in the horizontal direction, while the Y-axis denotes that in the vertical direction. When I_{ASP}>0, ERPS outperforms EHS in terms of ASP, and when I_{ASP}<0, EHS is significantly superior to ERPS. When the sequence differs, only the magnitude of C₁ varies, not the sign. A similar relationship is shown for and GRPS and GEHS (FIG. 1B).

Consequently, for purposes of an adaptive algorithm 100 shown in FIG. 1 it is easy to decide which search algorithm (GRPS or GEHS) is better, as long as the motion vector standard deviations of a video sequence can be computed at step 120. A threshold at step 130 is based on a determination that the variances are such that I_{ASP} equals zero. This threshold can be approximated by a linear function, and thus we the following analysis to decide which algorithm to use:

A·STD_{X}+B·STD_{Y}=TH

where A, B, and TH are determined by a conventional numerical method.

Depending on the result of threshold analysis step 130, the invention then selects preferably either one of two search pattern sets, namely the genetic enhanced rhombus search patterns (GRPS) at step 140 or the genetic enhanced hexagonal search patterns (GEHS) at step 150. Other pattern sets could also be considered of course. The operation of these two patterns is described further below, after which the adaptive procedure is terminated at step 160. The procedure can then be invoked as desired for a subsequent frame or sequence. Selection between GRPS and GEHS is by threshold with parameter A, B, Th, and MV standard deviations.

Similarly, selection between ERPS and EHS is by threshold with parameter P, Q, R and MV variances in accordance with the following formula:

P·VAR_{X}+Q·VAR_{Y}=R

where P, Q, and R are determined by a conventional numerical method.

The differences between ERPS/EHS selection and GRPS/GEHS selection is due the linearity of the threshold in different domain.

For purposes of evaluating the threshold for GRPS/GEHS selection, the standard deviations of motion vectors are preferably obtained from the motion vectors in the previous frame. The threshold can be determined by examining the I_{ASP} diagram in FIGs. 1B and 1C. The invention preferably uses standard deviation instead of variances, because I_{ASP} shows better linearity in standard deviation domain.

To determine C1 and C2 experimentally, preferably one of two different techniques can be used. In a first approach, a fixed search algorithm can be evaluated against different sequences of image frames. Alternatively a fixed image sequence could be used, and the search algorithm could be varied. Either approach should yield acceptable values for C1 and C2 for any particular application. Other approaches will be apparent to those skilled in the art.

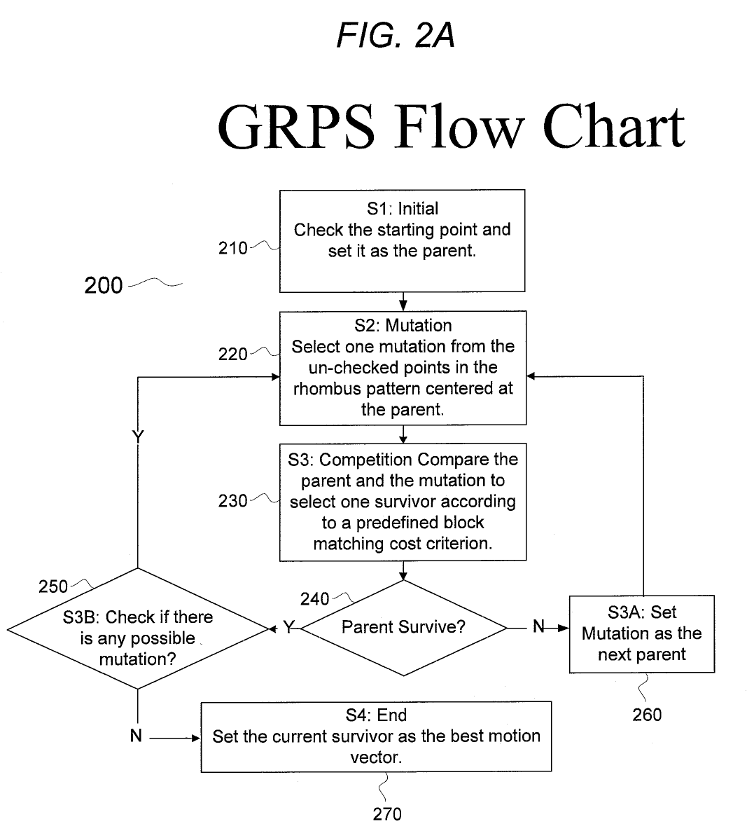

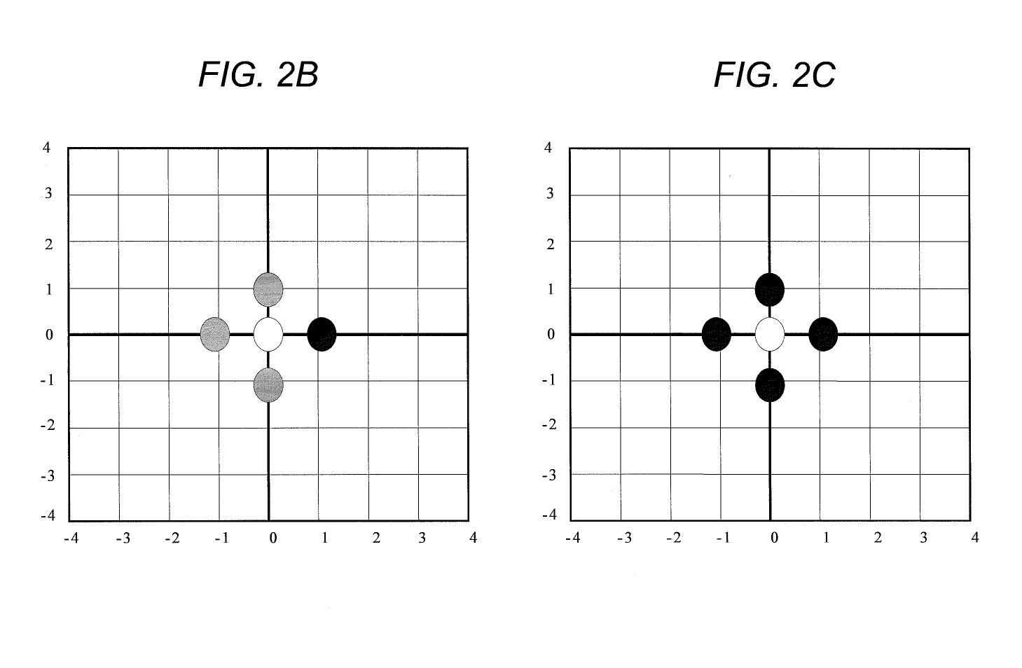

A preferred operation of a genetic rhombus pattern shape (GRPS) procedure 200 is depicted in FIG. 2A, along with the diagrams of FIGS. 2B and 2C. An initial parent starting point is designated at step 210, which is surrounded by 4 candidate children points along a perimeter of a rhombus shaped region. That is, in FIG. 2B, the initial parent starting point is indicated as a hollow white dot. Preferably a sum of absolute differences calculation for a block centered at such point in the present frame is computed against a corresponding point in a prior reference frame.

At step 220 one of the child search points is selected (either at random or based on some prior knowledge of a prior motion vector) to be checked. This point is designated with a solid black dot in FIG. 2B. A block centered about such point is then evaluated (preferably in accordance with the same type of calculation as for the initial parent) at step 230 to determine which of the two points should be declared the winner/survivor based on a block matching cost criterion.

As seen in step 260, if the present selected child is the winner, it is then designated as the new parent for purposes of identifying motion vectors in a subsequent search. Control then returns to step 220 with the selected child designated as the new parent. If instead the parent is the survivor based on the cost comparison, the procedure takes a path to step 250, where it is determine if another child is available for comparison. If this is true, control is passed to step 220 and the process is repeated, until all available children are inspected, as seen in FIG. 2C. If it is false, then the current surviving parent is selected at step 270 as identifying the best motion vector for the frame.

Thus the preferred process selects a winner preferably as between two candidate points and then discards the loser in favor of the winner. Preferably no attempt is made to evaluate all potential children, or to rank them and then select a winner. Rather, a continuous 1:1 comparison is made to designate a new parent. It is only in the case where a child fails to supplant/replace a parent that a second child is checked. Such point would then be evaluated as above for the first point to see if it can survive against the parent.

Consequently a significant reduction in computation time is achieved because the invention does not check every possible child within the pattern. It will be appreciated that the above approach could be modified as needed to approach the behavior of a conventional shaped based pattern search. In other words, it is possible that two or more children could be measured and compared to determine a winner. In the limit all the children could be checked to imitate the behavior of a conventional pattern search. Thus only in the worst case does the present invention approach the performance of a prior art approach.

Moreover as noted above it is possible to use prior motion vector information in the decision process of how to pick from among the possible children to be evaluated for the next surviving parent. That is, given the motion vector data, one could predict that the next surviving parent is likely to be another child lying along the same vector, and thus select that as the next checking (search) point. Other variations will be apparent to those skilled in the art.

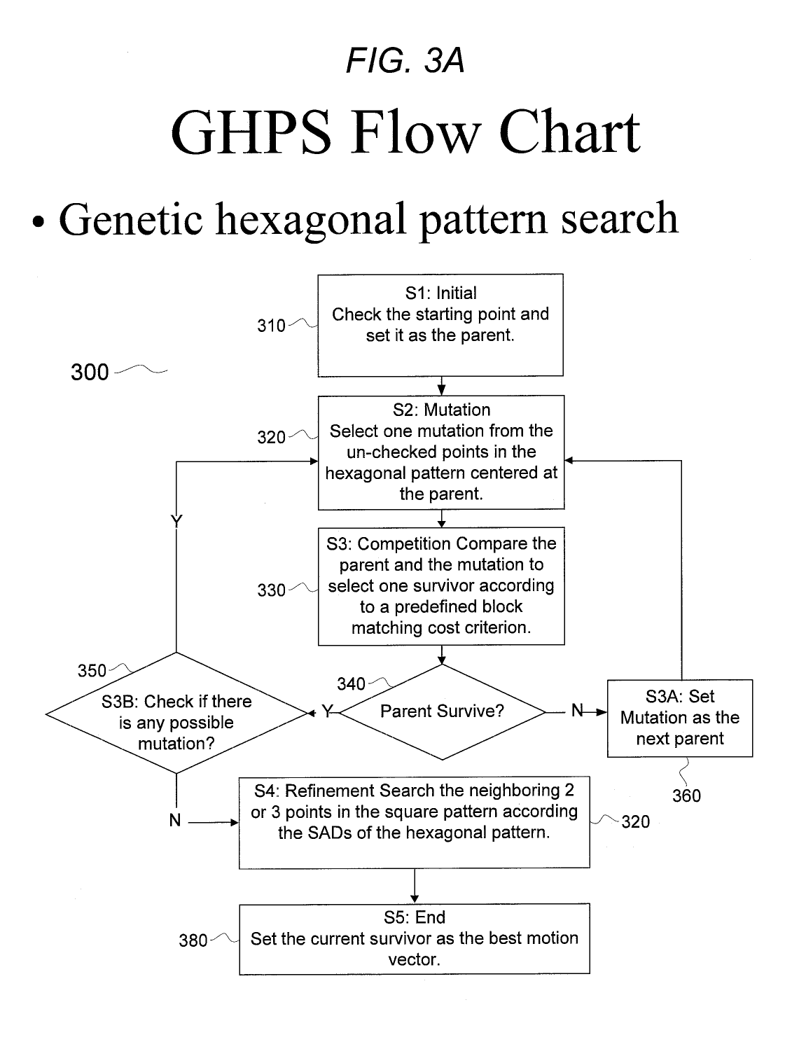

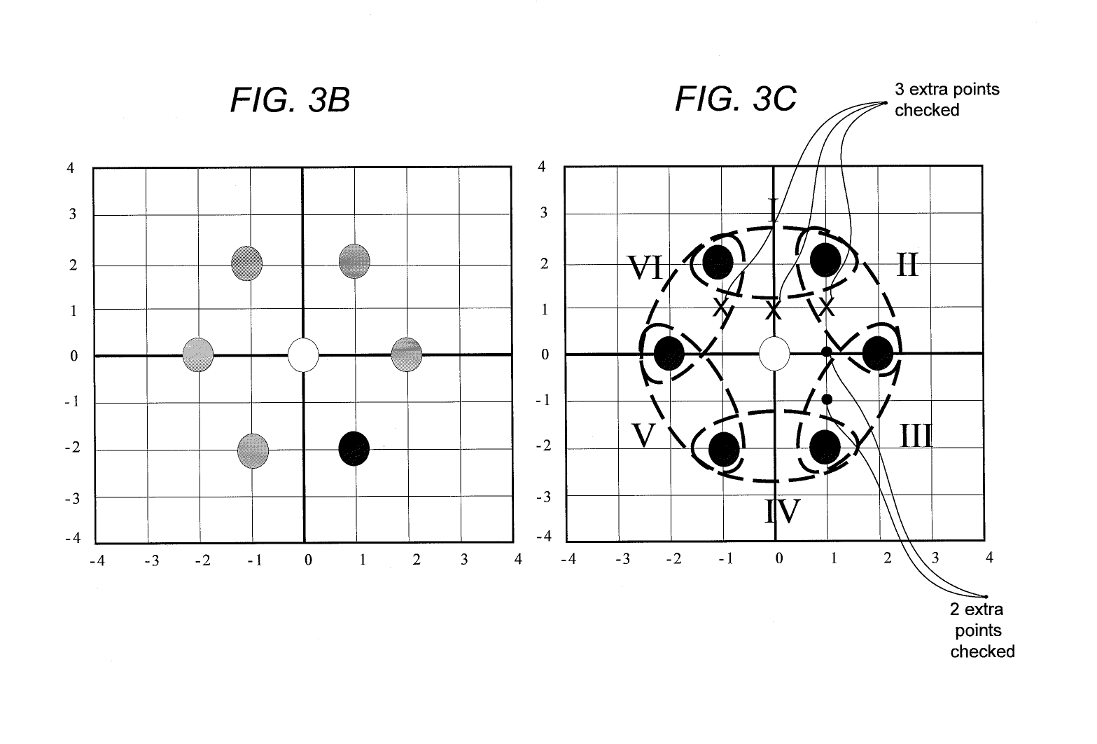

A similar approach is used in a preferred genetic enhanced hexagonal search (GEHS) procedure 300 shown in FIGS. 3A-3C. As above, steps 310, 320, 330, 340 350 and 360 are essentially the same as for the GRPS procedure. However in the hexagonal search process, an additional optional refinement procedure can be used beginning with step 370.

Namely, at 370 a block matching cost operates on more than a single point; namely, the sums of the neighboring two points in the hexagonal pattern (Groups I-VI in FIG. 3C) to determine which search pattern to be used next. Specifically, when the smallest sum is in Groups II, III, V, and VI in FIG. 3C, two extra points are checked as noted in the diagram. Alternatively if the smallest sum is in Group I and IV in FIG. 3C, three extra points are checked.

In other words additional candidate children are derived preferably by analyzing a gross motion vector direction determination. So in FIG. 3C, if the children in Group I have a lowest overall SAD compared to other child pairs, then the additional points marked with a cross would be selected as potential children to be evaluated against the original initial parent. This additional refinement would determine if the vertical predicted movement is accurate or not.

Similarly, if the children in group III have a collective SAD which is lowest, then the procedure would check the additional points noted, again to fine tune the final selection for a surviving parent. Thus, this particular genetic search pattern includes both a coarse and a fine tuning operation for better pinpointing an appropriate survivor.

### BME Circuits and Systems

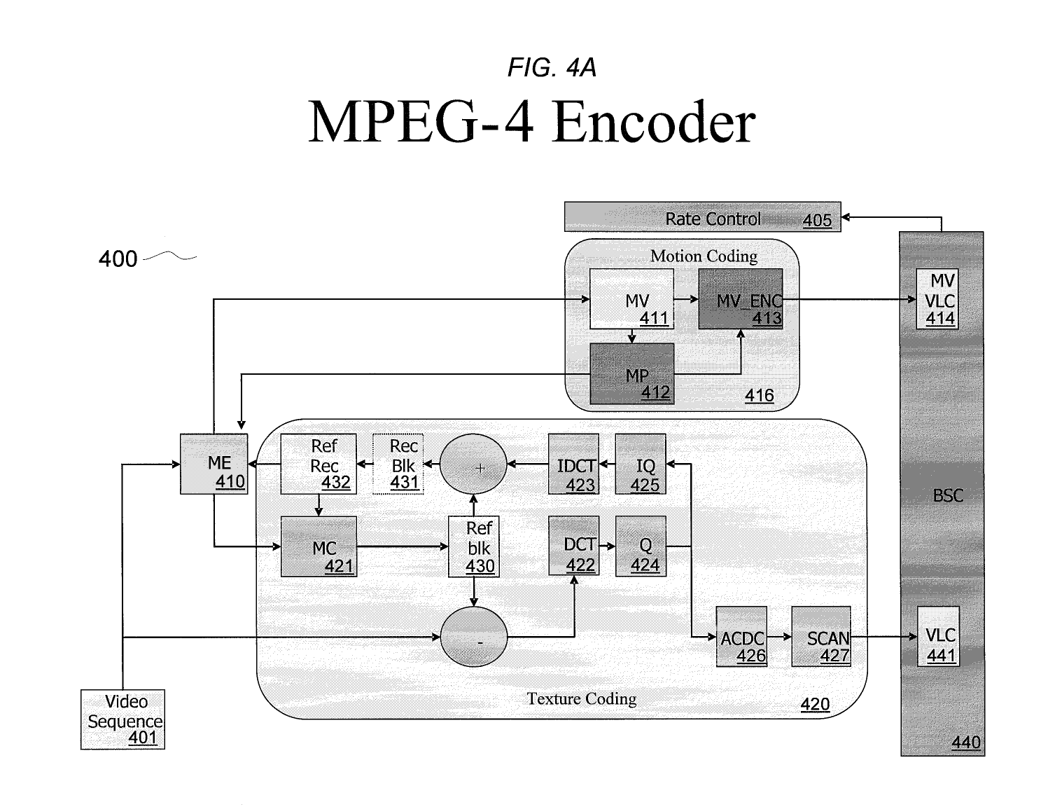

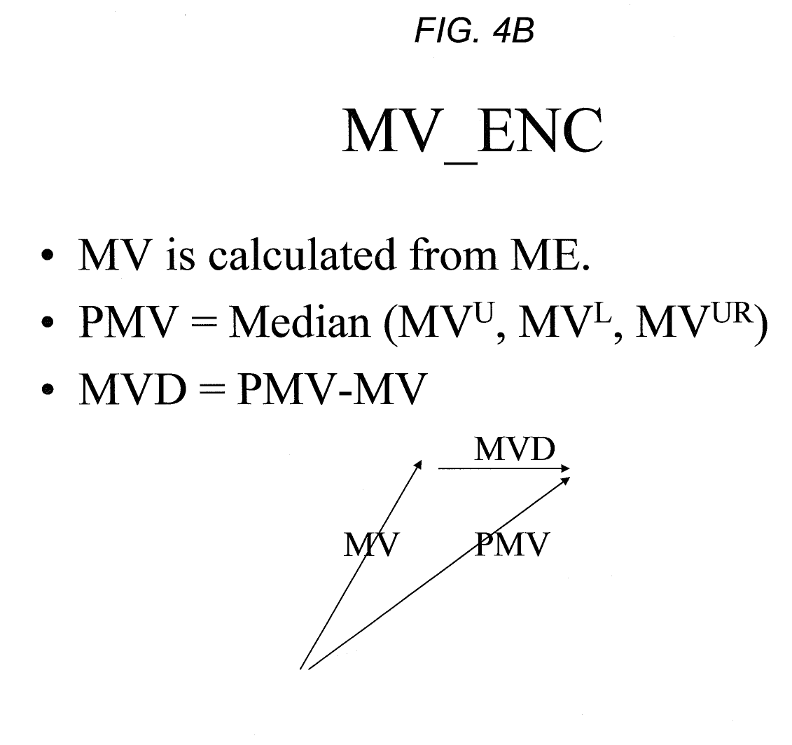

A preferred embodiment of a circuit/system 400 suitable as an MPEG compatible encoder is shown in block diagram form in FIG. 4A. It will be understood that this circuit could be implemented as part of a single integrated circuit (IC) coder, or in more distributed form. The individual operational circuit blocks may be implemented entirely in hardware, or functionally by firmware code executed by a digital signal processor or similar processing circuit. In some applications the bulk of the operations can be performed by a conventional microprocessor executing customized software code. Other implementations are also possible of course depending on the intended environment.

As seen in FIG. 4A, the main circuit components/blocks of an MPEG Encoder 400 which are preferably used for processing an image sequence 401 (in a preferred embodiment a sequence of digital image frames) include:

RC: rate control 405, which regulates and output bit rate of encoder 400;
ME: motion estimation circuit 416, which implements the aforementioned adaptive search patterns, including one of GRPS and/or GEHS;
A motion coding sub-circuit 410 which includes:
MV: a local storage 411 for motion vectors which can be implemented as some form of random access memory, including DRAM;
MP: motion prediction block 412, which calculates a predictive motion vector (PMV);
MV_ENC: block 413 which calculates the motion vector differences (MVD); the mathematical calculation is shown in vector form in FIG. 4B; in FIG. 4B the terms MV^{U} refer to the adjacent upper block of the current block, MV^{L} refer to the adjacent left block of the current block, and MV^{UR} refer to the neighboring up-right block of the current block. an output of motion coding subcircuit is coupled to MV_VLC block 414 which entropy codes the motion vector differences;
BSC bit-stream composer subcircuit 440 also includes VLC block 441 is responsible for entropy coding of the texture residues/compresses the image data;
Texture coding subcircuit 420 includes the following components:
MC: motion compensation block 421, which performs the inverse functions of ME bock 410;
DCT: discrete cosine transform block 422, which transforms residue coefficients from a spatial domain to a frequency domain.
IDCT: inverse discrete cosine transform block 423, which implements the inverse functions of DCT block 422;
Q: quantization block 424, which quantizes the residues;
IQ: inverse quantization block 425, which implements the inverse functions of Q block 423.
ACDC: alternating current/direct current prediction block 426, which eliminates intra-frame dependencies;
SCAN: zig-zag scan block 427, which preferably orders the coefficient in a “energy-concentrated” manner;
Rec Blk: Storage 431 for a reconstructed block.
Ref Blk: Storage 430 for reference block.
Ref/Rec: Storage 432 for the reconstructed block and reference block—i.e. the reconstructed block in current frame forms the succeeding reference frame.

Those skilled in the art will also appreciate that this figure is simplified to better illustrate the material aspects of the present invention, and that other relevant supporting hardware may be omitted for purposes of clarity.

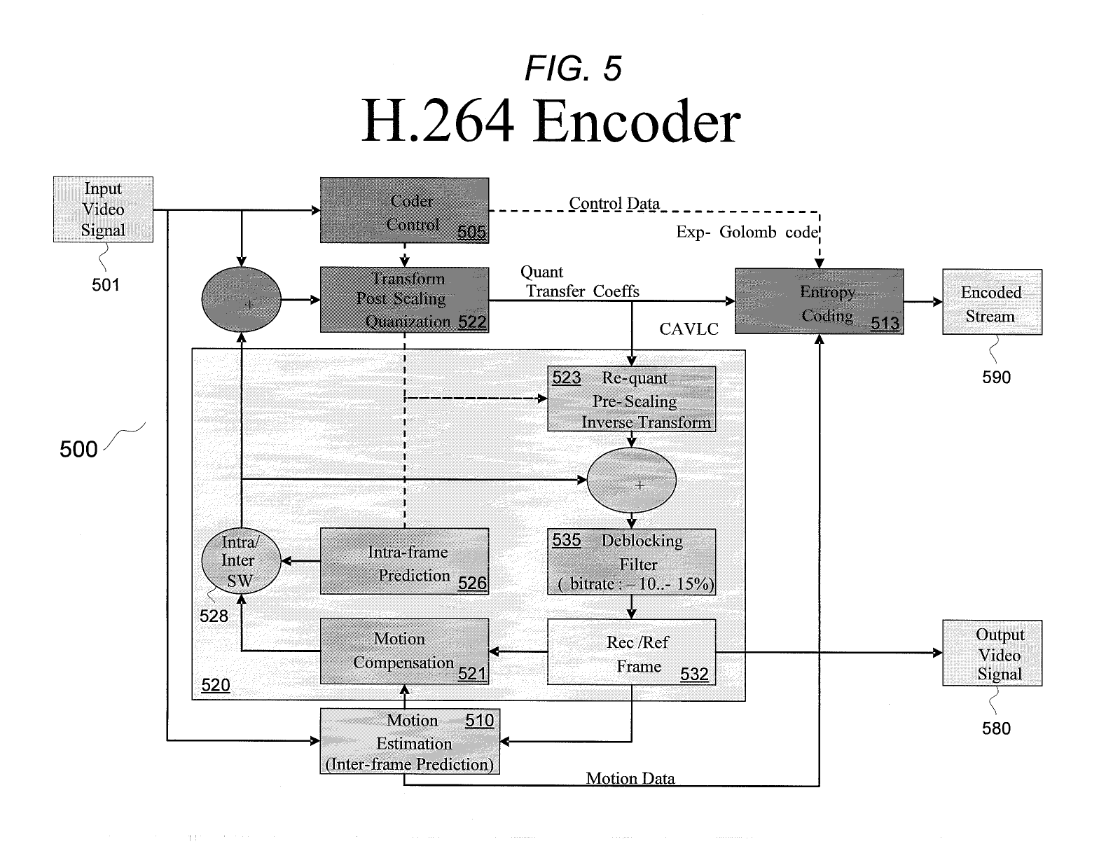

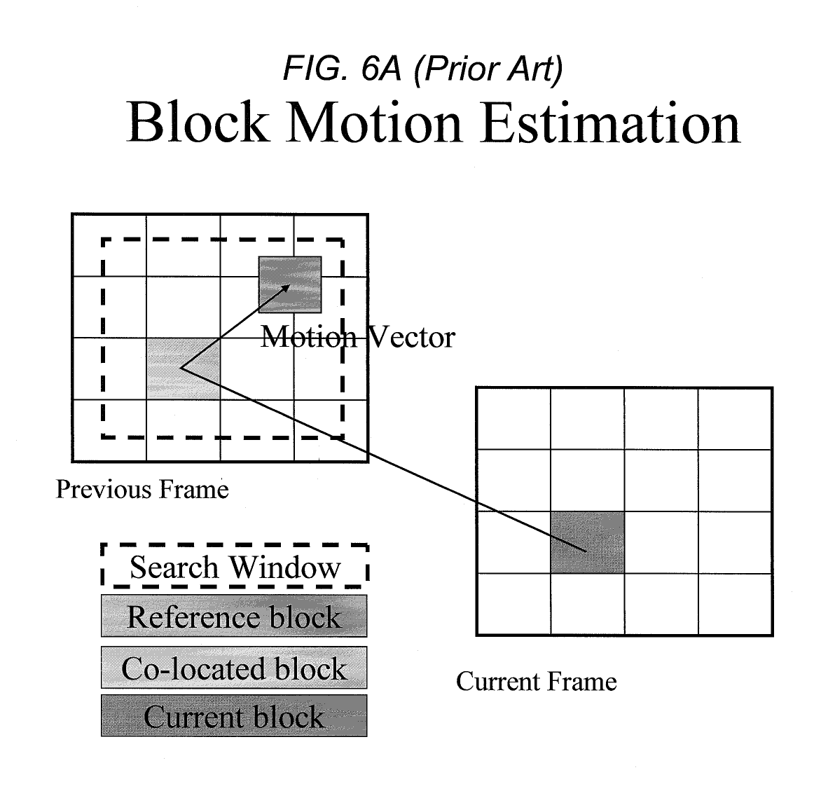

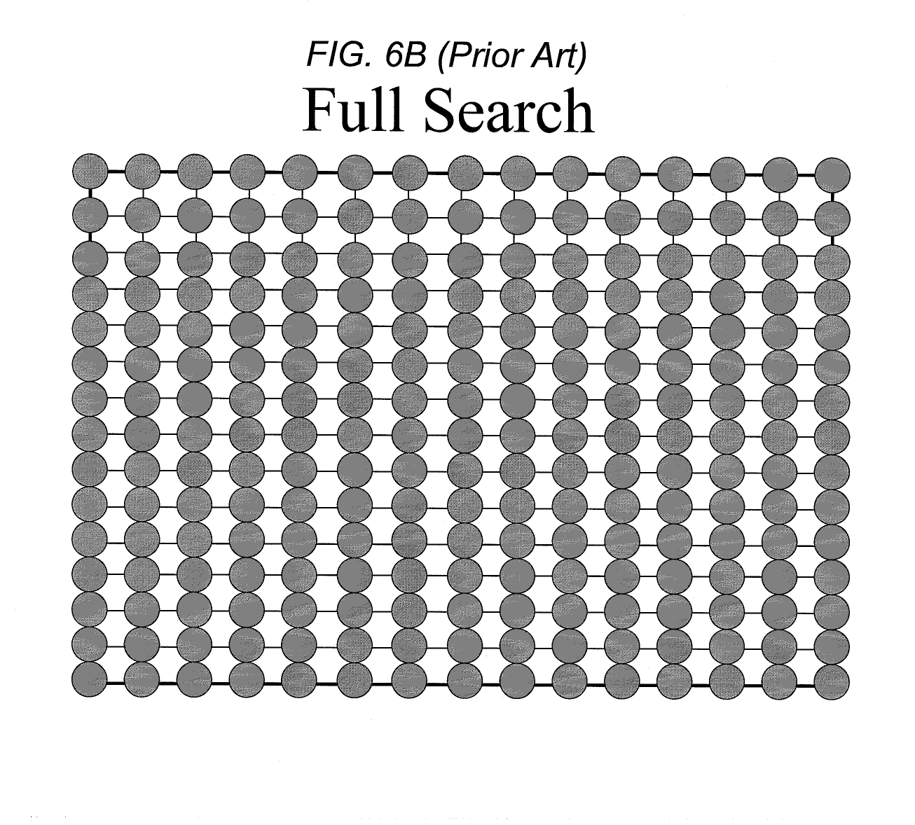

A preferred embodiment of a comparable circuit/system 500 suitable as an H.264 compatible encoder is shown in block diagram form in FIG. 5. This diagram is adapted from the Weigand reference mentioned above. For the most parts the encoder includes circuitry and blocks which imitate the operations and behavior of MPEG encoder 400, as both use a block based hybrid video coding structure. A mapping/comparison of their components is shown in the table below:

TABLE 1

| H.264 | MPEG-4 | Differences |
|---|---|---|
| Transform/Scaling/ | Q/DCT | H.264 uses integer transform and |
| Quantization | | linear quantizer with scaling. |
| Re-Quant/Pre-scaling/ | IQ/IDCT | H.264 uses integer inverse |
| Inverse Transform | | transform and linear inverse |
| | | quantizer with scaling. |
| Intra frame prediction | ACDC | H.264 supports intra prediction |
| | | modes. |
| Motion Estimation | ME | H.264 supports multiple |
| | | reference frames, variable block |
| | | size motion estimation, as well as |
| | | more precise fractional pixel |
| | | motion |

The structure/operation of the blocks required for processing video signal 501 to generate an encoded stream 590 and output signal 580 are well-known and include the following:

Coder control block 505;

Motion estimation block 510—which implements the procedures of the present invention as noted above;

Entropy coding block 513;

Motion compensation block 521;

Transform/Scaling/Quantization block 522;

Re-Quant/Pre-scaling/Inverse Transform block 523

Intra/inter switch 528;

Intra-frame prediction 526;

Rec/Ref Frame storage 532;

Deblocking filter 535

The details of such block are set out more explicitly in the aforementioned Weigand reference. As with MPEG encoder 400, the present H.26x encoder can be implemented in a variety of hardware/software/firmware combinations.

### Prediction Procedures

As disclosed in the attached Appendix, the theory underlying the present invention makes use of a flexible statistical model for evaluating and optimizing new search patterns. The preferred model utilizes a statistical probability function for characterizing the behavior of motion vectors. As set out below in the Appendix, the PDF can be equated with the variance of motion vectors, and the latter is easily obtainable from frame data. The weighting function of each search pattern is also considered to determine an appropriate search.

A comparative analysis of the average search point (ASP) cost reveals that the model is extremely effective in helping to devise and formulate new types of search patterns. The new GRPS and GEHS algorithms were in fact derived from such models, and other examples will be obtainable by skilled artisans from the present teachings. From the test/simulation data provided in the Appendix it is apparent the ASP savings of the present genetic based search patterns is substantial. Therefore it is expected that other types of search patterns can be estimated and deployed in other applications based on the present teachings.

A key observation gleaned from the present teachings is that the behavior and performance of new types of search patterns can be estimated preferably based on the performance achieved by a so-called full search (US) algorithm. That is, for any particular image sequence, the ASP of each search pattern can be calculated based on the weighting function for such pattern coupled with the motion vector PDU (or variances) determined by a US algorithm. This allows one to study pre-recorded or stored image data and glean an appropriate search pattern for individual collections of sequences. This additional control data can then be stored or passed on as needed for a later decoding operation if desired. Thus the disclosed model allows one skilled in the art to select an optimal search pattern for a particular image sequence, because the performance of individual algorithms can be estimated to select a best candidate.

Conversely the tools for estimating such performance can be valuable time savers therefore for practitioners to evaluate and determine the performance of a new search pattern against a variety of video sequences. From such predictions it is much easier to understand and appreciate the expected behavior of a new search algorithm before it is completely field tested or deployed.

The computational requirements for a circuit/software block can be evaluated based on using a particular search algorithm. This is useful for planning overall circuit/IC design as well.

The above descriptions are intended as merely illustrative embodiments of the proposed inventions. It is understood that the protection afforded the present invention also comprehends and extends to embodiments different from those above, but which fall within the scope of the present claims.

What is claimed is:

1. An adaptive method of performing block motion estimation comprising:
a. calculating a motion vector variance for at least a first frame;
b. determining a relationship of said motion vector variance to a first threshold for said at least first frame;
c. based on step (b):
i. selecting a first search pattern for identifying one or more search blocks in a second frame when said motion vector variance has a first relationship to said first threshold;
ii. selecting a second search pattern for identifying one or more search blocks in said second frame when said motion vector variance has a second relationship to said first threshold;
wherein block motion estimation is performed adaptively for one or more frames.

2. The method of claim 1, wherein said first relationship requires that said motion vector variance exceed said first threshold.

3. The method of claim 1, wherein said second relationship requires that said motion vector variance be equal or less than said first threshold.

4. The method of claim 1, wherein both said first search pattern and said second search pattern are based on genetic algorithms.

5. The method of claim 4, wherein said first search pattern is also based on a rhombus shaped algorithm, and said second search pattern is based on a hexagonal shaped algorithm.

6. The method of claim 4, wherein both said first search pattern is adapted for frames in which there is relatively small motion between candidate blocks, and said second search pattern is adapted for frames in which there is relatively large motion in candidate blocks.

7. The method of claim 1, wherein said motion vector variance is determined by analyzing an immediately prior frame.

8. The method of claim 1, wherein said motion vector variance is determined by analyzing a sequence of prior frames.

9. The method of claim 1 wherein data for said motion vector variance is coded and integrated as part of a video sequence.

10. The method of claim 1, wherein said motion vector variance is estimated prior to playback of a sequence of frames.

11. The method of claim 1, further including a step: predicting a motion vector variance for a subsequent frame.

12. A genetic based method of performing block motion estimation for a frame in connection comprising:
a) identifying a parent starting point within the frame;
b) randomly selecting a child point proximate to said first parent starting point;
c) comparing a first block matching cost for said parent point and a second block matching cost for said child point;
d) based on the results of step (c) setting either said parent point or said child point as a new surviving parent starting point;
e) repeating steps (b)-(d) with said new surviving parent starting point acting as said parent starting point until all child points have been examined for one more successive new surviving parent starting points;
f) identifying a motion vector for the frame based on a final surviving parent starting point from said successive new surviving parent starting points.

13. The method of claim 12 wherein said child point is immediately adjacent to said first parent starting point.

14. The method of claim 12 wherein said first block matching cost is determined by comparing a sum of absolute differences for said child point and said first parent starting point.

15. The method of claim 12 further including a step: a) determining a distance to be used for said child point.

16. The method of claim 15 wherein a first distance is used when there a variance between motion vectors in a prior frame exceeds a predetermined threshold, and a second distance is used otherwise.

17. The method of claim 12 wherein said child points consist of a predetermined pattern or a set of predetermined patterns.

18. The method of claim 12, wherein during step (d) a further determination is made concerning a direction of said new surviving parent starting point.

19. The method of claim 18 wherein a number of additional child points checked in step (e) is based on whether a direction of said new surviving parent starting point is vertical or horizontal.

20. A genetic pattern-based method of performing block motion estimation for a frame comprising:
a) performing a block matching operation to identify a parent starting point within the frame;
b) randomly selecting a child point from a perimeter portion of a rhombus centered about said parent starting point;
c) comparing a first block matching cost for said parent point and a second block matching cost for said child point;
d) based on the results of step (c) setting either said parent point or said child point as a new surviving parent starting point;
e) repeating steps (b)-(d) with said new surviving parent starting point acting as said parent starting point until all child points have been examined for one more successive new surviving parent starting points;
wherein said child points are also determined by reference to a rhombus pattern centered about said new surviving parent starting point;
f) identifying a motion vector for the frame based on a final surviving parent starting point from said successive new surviving parent starting points.

21. The method of claim 20, further including a step: determining a motion vector variance prior to selecting said rhombus as a pattern for block matching.

22. The method of claim 20, wherein a first child point which is determined to have a lower block distortion than said parent starting point is selected for said new surviving starting point without computing block distortions of other remaining unchecked child points.

23. A genetic pattern-based method of performing block motion estimation for a frame in connection comprising:
a) performing a block matching to identify a parent starting point within the frame;
b) randomly selecting a child point from a perimeter portion of a hexagon centered about said parent starting point;
c) comparing a first block matching cost for said parent point and a second block matching cost for said child point;
d) based on the results of step (c) setting either said parent point or said child point as a new surviving parent starting point;
e) repeating steps (b)-(d) with said new surviving parent starting point acting as said parent starting point until all child points have been examined for one more successive new surviving parent starting points;
wherein said child points are also determined by reference to a hexagonal pattern centered about said new surviving parent starting point;
f) identifying a motion vector for the frame based on a final surviving parent starting point from said successive new surviving parent starting points.

24. The method of claim 23, further including a fine searching operation is performed on selected points situated between said parent starting point and said child points situated on said hexagon perimeter portion.

25. The method of claim 24 wherein said selected points are determined by ranking and identifying which of said child points constitutes a minimum block distortion among said child points.

26. The method of claim 24, wherein a number of selected points which are examined for said fine searching operation is based on whether a horizontal or vertical direction is detected for said motion vector.

27. The method of claim 26 wherein fewer selected points are examined when a horizontal direction is detected.

28. The method of claim 23, wherein a first child point which is determined to have a lower block distortion than said parent starting point is selected for said new surviving starting point without computing block distortions of other remaining unchecked child points.
